(19) United States
(12) Patent Application Publication
(10) Pub. No.: US 2022/0214087 A1
(43) Pub. Date: Jul. 7, 2022

(54) THERMO-HYGROSTAT AIR CONDITIONER USING HEAT PUMP AND METHOD FOR CONTROLLING THERMO-HYGROSTAT AIR CONDITIONER

(71) Applicant: LG Electronics Inc., Seoul (KR)

(72) Inventors: Jaewan Lee, Seoul (KR); Sangmoo Kim, Seoul (KR); Joonwoo Kim, Seoul (KR)

(21) Appl. No.: 17/554,227

(22) Filed: Dec. 17, 2021

(30) Foreign Application Priority Data
Jan. 4, 2021 (KR) 10-2021-0000473

(51) Int. Cl. F25B 41/20; F25B 49/02; F25B 41/31; F25B 41/42

(52) U.S. Cl. CPC F25B 41/20; F25B 49/02; F25B 41/31; F25B 2600/2515; F25B 2700/02; F25B 2700/2106; F25B 41/42

(57) ABSTRACT

A thermo-hygrostat air conditioner is provided that may include at least one indoor unit installed indoors, and including a main coil that provides air that meets a predetermined humidity by dehumidifying outdoor air and a sub coil that cools or heats the dehumidified air at a predetermined temperature and provides the air indoors; and an outdoor unit connected to the main coil and the sub coil of the indoor unit via a refrigerant pipe and including at least one outdoor heat exchanger, at least one compressor, at least one outdoor expansion valve and at least one four way valve. A mode of the main coil and the sub coil may be determined depending on a cooling load and a heating load. The outdoor unit may control the four way valve according to the mode of the main coil and the sub coil and provide refrigerant to the main coil and the sub coil according to the mode.

### CROSS-REFERENCE TO RELATED APPLICATION(S)

This application claims the priority benefit of Korean Patent Application No. 10-2021-0000473, filed in Korea on Jan. 4, 2021 in the Korean Intellectual Property Office, the disclosure of which is incorporated herein by reference.

### BACKGROUND

### 1. Field

A thermo-hygrostat air conditioner and a method for controlling a thermo-hygrostat air conditioner, more specifically, a thermo-hygrostat air conditioner capable of operating in all operation modes using a simultaneous type heat pump are disclosed herein.

### 2. Background

A thermo-hygrostat air conditioner is a device that maintain a temperature and moisture inside of a required space in a desired condition. In general, the thermo-hygrostat air conditioner performs cooling and dehumidification using a compression refrigeration device or performs cooling, heating, and dehumidification using a plurality of heat pumps, respectively.

The thermo-hygrostat air conditioner in Korean Registration Patent No. 10-0938820, which is hereby incorporated by reference, includes a plurality of heat pump type heating and cooling devices. Any one of a first to a second heat pump type heating and cooling devices works in a cooling mode depending on a dehumidification capacitance and a degree of temperature reduction at dehumidification mode, and works in the other in any one of a stop work, heating, or dehumidification mode, or any one of the first to the second heat pump type heating and cooling devices works in a dehumidification mode and works in the other in any one of a stop work, dehumidification, or heating mode. This prior art has a problem that a plurality of heat pump type heating and cooling devices are required increasing costs for installation and maintenance and energy consumption, and in use of space because a separate heating and cooling device is added to an existing heating and cooling device.

To address these problems, a simultaneous type of product was developed and operated by manufacturers not only in Korea, but also in Japan, China, and many other countries. The simultaneous type product is able to operate a plurality of indoor coils simultaneously in heating and cooling modes. However, as the simultaneous type product controls a flow of refrigerant to each coil by combining a heat recovery unit to form a cycle, it has disadvantages in that a composition of the cycle is complicated and costs increase.

The prior art address this disadvantage, in Korean Patent Application Publication No. 10-2012-0082975, by providing a cycle that supplies hot gas to a reheat coil(heating) branched from a pipe connected to a discharge of a compressor of an outdoor unit of a general heat pump, joining liquid refrigerant condensed at the reheat coil and liquid refrigerant condensed at the outdoor unit, expanding at an expansion side and supplying it to a main coil (cooling), and evaporating and recovering low-pressure refrigerant to the outdoor unit. By dividing the reheating coil and controlling a flow rate of each component by turning on/off a solenoid valve, an amount of reheating heat is controlled, and reliability is ensured by controlling the solenoid valve so that the flow of condensed refrigerant discharged from the compressor is not blocked.

This prior art has an advantage of being able to control a case in which reheating is required after cooling and dehumidification required in the thermo-hygrostat air conditioner, by one outdoor unit but has the following problems.

First, as the heating coil is only used in a heating operation, there is a negative effect that efficiency of the cycle drops because the reheating coil leads to a pressure loss when reheating is not required.

Second, if the heating load is larger than a cooling load, a sufficient amount of reheat cannot be supplied, because a larger amount of heat than the amount of heat evaporated in the evaporator cannot be supplied to the condenser. Hence, for a stable reheat control, a design of the heating equipment, such as electricity/steam, is additionally required.

Third, as the pressure loss of intermediate cycle components, for example, a service valve, solenoid valve, when hot gas is supplied to the reheat coil by branching from the hot gas pipe of the general heat pump outdoor unit, it is difficult to supply a sufficient reheat amount compared to the amount of cooling heat. As the reheat coil is divided and the supply of hot gas to each component is controlled by turning on and off the solenoid valve, it is difficult to linearly control the amount of reheat, and liquid refrigerant accumulation in the reheat coil may occur.

Finally, use of many solenoid valves may increase the cost of installation and control, and failure frequency may increase.

### BRIEF DESCRIPTION OF THE DRAWINGS

Embodiments will be described in detail with reference to the following drawings in which like reference numerals refer to like elements, and wherein:

FIG. 1 is a schematic diagram of a thermo-hygrostat air conditioner according to an embodiment;

FIG. 2 is a schematic diagram of a thermo-hygrostat air conditioner for operating a mode thereof according to an embodiment;

FIG. 3 is an enlarged view of an indoor unit and a valve of a thermo-hygrostat air conditioner according to an embodiment;

FIG. 4 is a flow chart of a method for choosing a mode of the thermo-hygrostat air conditioner of FIG. 2;

FIG. 5 is an operation diagram showing circulation of refrigerant in mode 1 and mode 2 of the method of FIG. 4;

FIG. 6 is an operation diagram showing circulation of refrigerant in mode 3 of the method of FIG. 4;

FIG. 7 is an operation diagram showing circulation of refrigerant in mode 4 and mode 5 of the method of FIG. 4;

FIG. 8 is a flow chart of a method for controlling a degree of opening of each expansion valve of a valve in mode 4 of FIG. 7; and

FIG. 9 is an operation diagram showing circulation of refrigerant in mode 6 of the method of FIG. 4.

### DETAILED DESCRIPTION

Advantages and features will become apparent with reference to embodiments described hereinafter together with the accompanying drawings. However, the embodiments are not limited to the embodiments disclosed hereinafter but may be implemented in a variety of different forms. The embodiments are provided for complete disclosure and to fully inform the scope to those who skilled in the art to which the embodiments pertain. The disclosure is only defined by the scope of the claims. The same reference sign refers to the same elements throughout the whole specification.

The spatially relative terms “below”, “beneath”, “lower”, “above”, “upper”, etc., as shown in the drawing, can be used to easily describe the correlation between one component and other components. Spatially relative term should be understood as a term that includes different directions of components in use or in operation in addition to the directions shown in the drawing. For example, when the components shown in the drawing is flipped, A component described as “below” or “beneath” of another component may be placed “above” another component. Hence, the exemplary term “below” may include both directions below and above. Components may also be oriented in other direction, and accordingly, spatially relative term can be interpreted according to their orientation.

The terms used in the present specification are for describing exemplary embodiments and are not intended to limit. In this specification, the singular form also includes the plural form unless specifically stated in the phrase. As used in the specification, “comprises” and/or “comprising” means that the mentioned components, steps and/or actions do not exclude the presence or addition of one or more other components, steps and/or actions.

Unless there is another definition, all terms (including technical and scientific terms) used in the present specification may be used as meanings that can be commonly understood by those of ordinary skill in the art to which the present disclosure belongs. In addition, terms defined in a commonly used dictionary are not interpreted ideally or excessively unless explicitly defined specifically.

In the drawings, a thickness or size of each component is exaggerated, omitted, or schematically illustrated for convenience and clarity of description. In addition, the size and area of each component do not completely reflect the actual size or area.

Hereinafter, an embodiment will be described with reference to the drawings.

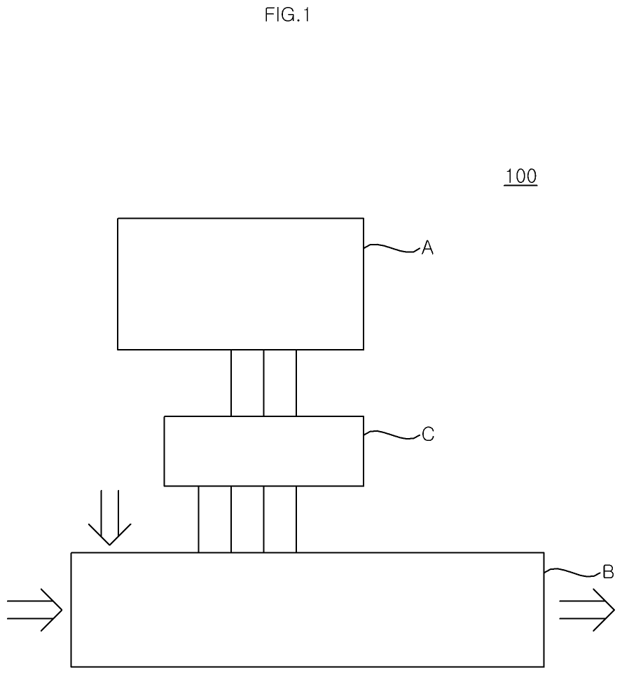

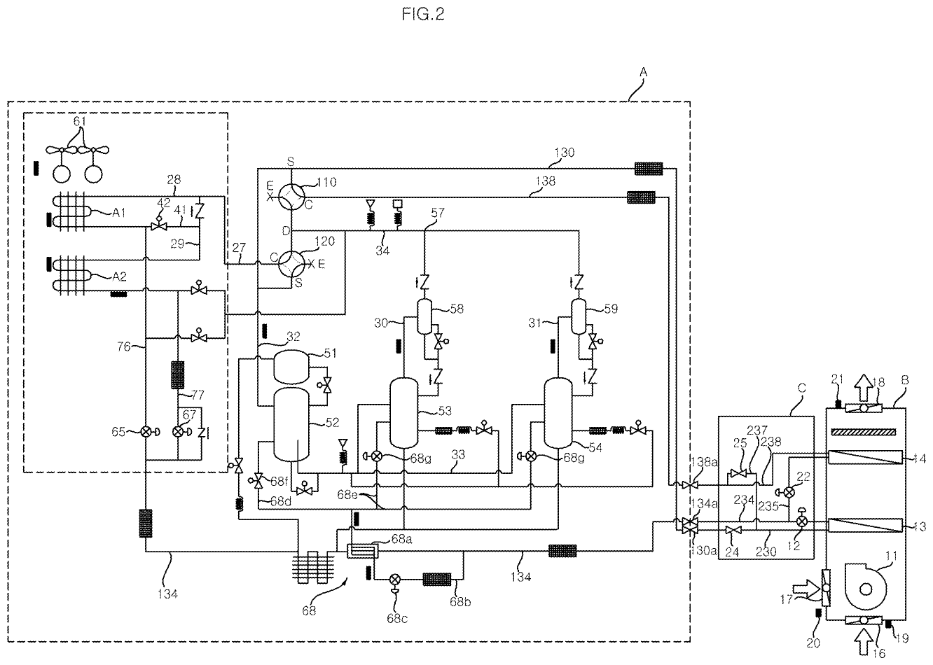

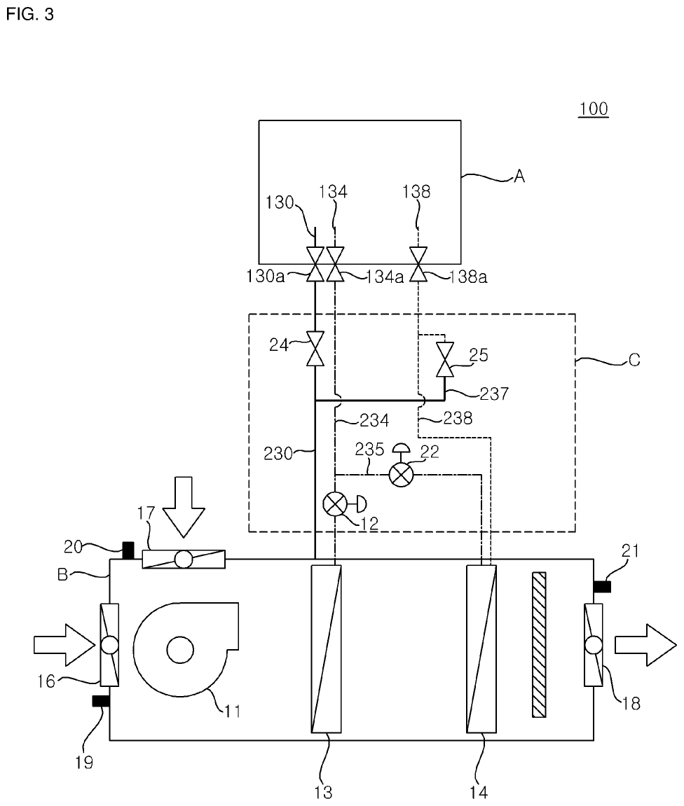

FIG. 1 is a schematic diagram of a thermo-hygrostat air conditioner according to an embodiment. FIG. 2 is a schematic diagram of a thermo-hygrostat air conditioner for operating a mode thereof according to an embodiment. FIG. 3 is an enlarged view of an indoor unit and a valve of the thermo-hygrostat air conditioner according to an embodiment.

Referring to FIGS. 1 to 3, thermo-hygrostat air conditioner 100 according to an embodiment is shown. The thermo-hygrostat air conditioner 100 may include a thermo-hygrostat indoor unit B, at least one thermo-hygrostat outdoor unit A, and a valve C.

The thermo-hygrostat outdoor unit A may provide air indoors with a set or predetermined target humidity by removing moisture from outdoor air and indoor air while interworking with the thermo-hygrostat indoor unit B, and may maintain a set or predetermined target temperature by reheating or cooling the air. That is, as a simultaneous type outdoor unit performing refrigerant circulation for dehumidification and refrigerant circulation for reheating simultaneously, it is possible to provide refrigerant with proper conditions corresponding to different modes of two heat exchangers disposed at one indoor unit B.

The thermo-hygrostat outdoor unit A may include an outdoor unit case (not shown), compressors 53, 54 disposed therein, outdoor heat exchangers A1, A2, an accumulator 52, four way valves 110, 120, oil separators 58, 59, outdoor expansion valves 65, 67, and a supercooling unit 68.

In the outdoor unit case (not shown), a first gas line valve 138a connected with a first gas line connection pipe 138, a second gas line valve 130a connected with a second gas line connection pipe 130, and a liquid line valve 134a connected with a liquid line connection pipe 134 are included. The liquid line valve 134a, the first gas line valve 138a, and the second gas line valve 130a are connected via the indoor unit B and the valve C and circulate refrigerant in the outdoor unit A.

An inverter compressor, that may control a discharge pressure of refrigerant and an amount of refrigerant by regulating an operation frequency, may be used for compressors 53, 54. The compressor according to this embodiment may be divided into first compressor 53 and second compressor 54. The first compressor 53 and the second compressor 54 may be disposed in parallel. In this embodiment, like FIG. 2, there are two compressors 53, 54; however, embodiments are not limited thereto and a different number of compressor may be provided.

In addition, each compressor 53, 54 may have a different capacity. Any one compressor 53, 54 may be an inverter compressor for which a number of rotation is changed, and the other compressor may be a constant speed compressor.

A bypass unit, that emits surplus oil to an outside of the compressors 53, 54 when excessive oil is stored inside of the compressors 53, 54, may be connected to each compressor 53, 54. The bypass unit may include a plurality of bypass pipes connected to each compressor 53, 54, respectively, and a common pipe that joins oil or refrigerant flowing along each bypass pipe. The common pipe may be connected to an accumulator discharge pipe 33.

The bypass pipe may be connected to each compressor 53, 54 at a higher position than an oil level required, at a minimum, for the compressors 53, 54, or an equal position. Depending on the oil level in the compressors 53, 54, only refrigerant, only oil, or both refrigerant and oil may be discharged through the bypass pipe.

A depressurizing portion that depressurizes fluid discharged from the compressors 53, 54, and a valve that adjusts a quantity of fluid flowing through the bypass pipe may be installed at the bypass pipe.

The oil separators 58, 59 may be disposed at a discharge side of the compressors 53, 54. The oil separators 58, 59 according to this embodiment may be divided into first oil separator 58 disposed at a discharge side of the first compressor 53 and a second oil separator 59 disposed at a discharge side of the second compressor 54. Refrigerant discharged from the compressors 53, 54 may flow into the four way valves 110, 120 via the oil separators 58, 59.

The oil separators 58, 59 may collect oil included in refrigerant discharged from the oil separators 58, 59 and then provide to the compressors 53, 54. The oil separators 58, 59 further include oil collecting pipes 30, 31 that guide oil to the compressors 53, 54, and a check valve that permits refrigerant to flow in one direction. The oil separators 58, 59 may be installed at a compressor discharge pipe 34.

An oil collecting structure, that collects oil to the compressors 53, 54, may be disposed at the accumulator 52. An oil collecting pipe that connects a lower side of the accumulator 52 and the accumulator discharge pipe 33, and an oil return valve that controls flow of air and disposed at the oil collecting pipe may be disposed in the oil collecting structure.

In this embodiment, outdoor heat exchangers A1, A2 may include first outdoor heat exchanger A1 and second outdoor heat exchanger A2. An outdoor blowing fan 61 may be disposed therein, to improve heat exchange.

An outdoor heat exchanger-first four way valve connection pipe 27, through which refrigerant flows, may be connected to the outdoor heat exchangers A1, A2. The outdoor heat exchanger-first four way valve connection pipe 27 may include a first outdoor heat exchanger-first four way valve connection pipe 28 that connects the first outdoor heat exchanger A1 and the first four way valve 110, and a second outdoor heat exchanger-first four way valve connection pipe 29 that connects the second outdoor heat exchanger A2 and the first four way valve 110. The outdoor heat exchanger-first four way valve connection pipe 27 connected to the first four way valve 110 may be divided into the first outdoor heat exchanger-first four way valve connection pipe 28 and the second outdoor heat exchanger-first four way valve connection pipe 29.

A check valve may be disposed at the second outdoor heat exchanger-first four way valve connection pipe 29 and prevent refrigerant supplied from the outdoor heat exchanger-first four way valve connection pipe 27 for flowing into the second outdoor heat exchanger-first four way valve connection pipe 29.

A variable path pipe 41 may connect a first heat exchanger pipe 76 and the second outdoor heat exchanger-first four way valve connection pipe 29, and a variable path valve 42 may be further disposed at the variable path pipe 41.

The variable path valve 42 may be operated selectively. When the variable path valve 62 is opened, refrigerant flowing along the first heat exchanger pipe 76 may pass through the variable path pipe 41 and the variable path valve 42, and may be guided to the first four way valve 110. When the variable path valve 42 is closed, in a heating operation, refrigerant supplied from the first heat exchanger pipe 76 may flow to the first heat exchanger A1. When the variable path valve 42 is closed, in a cooling operation, refrigerant passed through the first heat exchanger A1 may flow to the liquid line connection pipe 134 via the first heat exchanger pipe 76.

In the heating operation, the outdoor expansion valves 65, 66 expand refrigerant flowing to the heat exchangers A1, A2. In the cooling operation, the outdoor expansion valves 65, 66 do not expand refrigerant.

As the outdoor expansion valves 65, 66, an electronic expansion valve (EEV), that regulates a degree of opening of the valve, may be used.

The outdoor expansion valves 65, 66 may include first outdoor expansion valve 65 that expands refrigerant flowing into the first heat exchanger A1 and second outdoor expansion valve 66 that expands refrigerant flowing into the second heat exchanger A2. The first outdoor expansion valve 65 and the second expansion valve 66 may be connected with the liquid line connection pipe 134. In the heating operation, refrigerant condensed in the indoor unit B may be supplied to the first outdoor expansion valve 65 and the second outdoor expansion valve 66.

To be connected with the first outdoor expansion valve 65 and the second outdoor expansion valve 66, the liquid line connection pipe 134 is branched and connected to the first outdoor expansion valve 65 and the second outdoor expansion valve 66, respectively. The first outdoor expansion valve 65 and the second outdoor expansion valve 66 are disposed in parallel.

A pipe that connects the first outdoor expansion valve 65 and the first outdoor heat exchanger A1 is defined as the first outdoor heat exchanger pipe 76. A pipe that connects the second outdoor expansion valve 66 and the first outdoor heat exchanger A2 is defined as the second outdoor heat exchanger pipe 77.

The accumulator 52 accommodates and stores refrigerant and provides refrigerant to the compressors 53, 54. The accumulator 52 is disposed at a suction side of the compressors 53, 54 and is connected with the four way valves 110, 120.

The outdoor unit A according to this embodiment may further include a receiver 51. The receiver 51 may store liquid refrigerant to adjust a quantity of circulating refrigerant. The receiver 51 may store liquid refrigerant separately from liquid refrigerant stored in the accumulator 52.

The receiver 51 supplies refrigerant to the accumulator 52 when a quantity of circulating refrigerant is too low. The receiver 51 collects and stores refrigerant when the quantity of refrigerant is excessive.

A pipe that connects the outdoor expansion valve 65, 66 and a supercooling heat exchanger 68a on the liquid line connection pipes 134 may be defined as a supercooling liquid line connection pipe; however, embodiments are not limited thereto.

The four way valves 110, 120 are at the discharge side of the compressors 53, 54 and change a flow path of refrigerant flowing in the outdoor unit A. The four way valve 110, 120 properly switches a flow path of refrigerant discharged from the compressors 53, 54 depending on the cooling/heating mode of the thermo-hygrostat air conditioner 100.

The four way valve 110, 120 according to this embodiment may be divided into first four way valve 110, that provides refrigerant discharged from the compressors 53, 54 to the outdoor heat exchangers A1, A2 or provides refrigerant flowing in the outdoor heat exchangers A1, A2 to the compressors 53, 54 via the accumulator 52, and second four way valve 120, that provides refrigerant discharged from the compressors 53, 54 to the first gas line connection pipe 138 or provides refrigerant introduced from the first gas line connection pipe 138 to the compressors 53, 54 via the accumulator 52.

In addition, in the heating mode, the first four way valve 110 at an outdoor unit A side may provide refrigerant flowing into the outdoor heat exchanger A1, A2 to the compressors 53, 54 and to the first gas line connection pipe 138.

The first four way valve 110 and the second four way valve 120 according to this embodiment may allow refrigerant discharged from the compressors 53, 54 to pass through the four way valves 110, 120 in an off state and present refrigerant discharged from the compressors 53, 54 to not pass through the four way valves 110, 120 in an off state.

The air conditioner 100 according to this embodiment, in the cooling mode of the outdoor unit A, maintains the on state of the first four way valve 110 and maintains the off state of the second four way valve 120. The air conditioner 1 according to this embodiment, in the heating mode of the outdoor unit A, maintains the off state of the first four way valve 110 and maintains the on state of the second four way valve 120.

The air conditioner 100 according to this embodiment may include a hot gas unit in which a portion of refrigerant compressed in the compressors 53, 54 flows. A portion of refrigerant, with high temperature and high pressure, compressed in the compressors 53, 54 passes through a hot gas bypass pipe and flows into the outdoor heat exchangers A1, A2.

The hot gas unit may include the hot gas bypass pipe that passes refrigerant and a hot gas valve. For example, a first hot gas bypass pipe may connect the first outdoor heat exchanger pipe 76 and the compressor discharge pipe 34. One or a first end of the first hot gas bypass pipe may be connected to the first outdoor heat exchanger pipe 76 and the other or a second end thereof may be connected to the compressor discharge pipe 34. A second hot gas bypass pipe may be disposed to connect the second outdoor heat exchanger pipe 77 and the compressor discharge pipe 34. One or a first end of the second hot gas bypass pipe may be connected to the second outdoor heat exchanger pipe 77 and the other or a second end thereof may be connected to the compressor discharge pipe 34.

A first hot gas valve may be disposed at the first hot gas bypass pipe, and a second hot gas valve may be disposed at the second hot gas bypass pipe. A solenoid valve may be used for the first and the second hot gas valve which can regulate the degree of opening.

The first hot gas bypass pipe and the second hot gas bypass pipe may be connected to the compressor discharge pipe 34, respectively, or one pipe may be connected to the compressor discharge pipe 34 after being joined.

The supercooling unit 68 may be disposed at the liquid line connection pipe 134. The supercooling unit 68 may include supercooling heat exchanger 68a, a supercooling bypass pipe 68b bypassed from the liquid line connection pipe 134 and connected to the supercooling heat exchanger 68a, a supercooling expansion valve 68c disposed at the supercooling bypass pipe 68b and that selectively expands flowing refrigerant, a supercooling-compressor connection pipe 68e that connects the supercooling heat exchanger 68a and the compressors 53, 54, and a supercooling-compressor expansion valve 68g disposed at the supercooling-compressor connection pipe 68e and that selectively expands flowing refrigerant.

The supercooling unit 68 according to this embodiment may further include an accumulator bypass pipe 68d that connects the accumulator 52, the supercooling heat exchanger 68a, and the supercooling-compressor connection pipe 68e. The accumulator bypass pipe 68d may provide refrigerant in the accumulator 52, joined with supercooled refrigerant passed through the supercooling heat exchanger 68a, to the supercooling-compressor connection pipe 68e. A supercooling bypass valve 68f may further be disposed at the accumulator bypass pipe 68d.

The supercooling expansion valve 68c expands liquid refrigerant in the accumulator 52 and provides it to the supercooling heat exchanger 68a, and the expanded refrigerant evaporates at the supercooling heat exchanger 68a and cools the supercooling heat exchanger 68a. Liquid refrigerant flowing into the outdoor heat exchanger A1, A2 through the liquid line connection pipe 134 may be cooled while passing through the supercooling heat exchanger 68a. The supercooling expansion valve 68c may operate selectively and may control a temperature of the liquid refrigerant.

When the supercooling expansion valve 68c operates, the supercooling-compressor expansion valve 68g is opened and refrigerant flows into the compressors 53, 54. The supercooling bypass valve 68f may operate selectively and may provide liquid refrigerant in the accumulator 52 to the supercooling-compressor expansion valve 68g.

The supercooling-compressor expansion valve 68c may be operated selectively and may lower a temperature of refrigerant supplied to the compressors 53, 54 by expanding the refrigerant. When the temperature of the compressors 53, 54 exceeds a temperature range for normal operation, refrigerant expanded in the supercooling-compressor expansion valve 68e may be evaporated in the compressors 53, 54 to lower the temperature of the compressors 53, 54.

The air conditioner 100 according to this embodiment may further include a pressure sensor that measures a pressure of refrigerant, a temperature sensor that measures a temperature of refrigerant, and a strainer that removes alien substances in the refrigerant, for example, flowing in the refrigerant pipe.

The air conditioner according to this embodiment may include the refrigerant pipes 134, 138 in which refrigerant flows and that connect the outdoor unit A, the indoor unit B, a dedicated outdoor air ventilation system D, and the second gas line connection pipe 130 that connects the plurality of outdoor unit A, indoor unit B, and the valve C. The refrigerant pipes 130, 134, 138 may be divided into the liquid line connection pipe 134, and the first and the second gas line connection pipes 138, 130 in which gaseous refrigerant flows.

The liquid line connection pipe 134, the first and the second gas line connection pipe 130, 138 may be elongated inside of the outdoor unit A. According to the mode, gas state refrigerant with low or high pressure may flow in the first and the second gas line connection pipe 130, 138.

At least one thermo-hygrostat indoor unit B may be installed indoors; however, embodiments are not limited thereto.

An outdoor air suction hole 16, through which outdoor air may be suctioned, may be installed at a front part inside of the indoor unit case (not shown), and a filter (not shown), that removes dust, may be formed at a rear surface of the outdoor air suction hole 16. An indoor circulation air suction hole 17, through which indoor circulating air may be suctioned, may be installed at an upper surface of the front part of the at least one thermo-hygrostat indoor unit B. The filter (not shown) may be formed at a rear surface of the indoor circulation air suction hole 17. A main coil 13, for dehumidifying to reach the target humidity in a state in which the outdoor air and the indoor circulating air are mixed, may be installed at the rear surface the filter.

The main coil 13 may mainly operate as an evaporator to lower the humidity of mixing air to the target humidity that the user sets, and the heat exchanger may operate as a condenser when it reaches the target humidity in some cases. When the main coil 13 operates as the evaporator, it is possible to reach the target humidity by lowering the humidity of mixed air, that is, the outdoor air and the indoor circulating air which are mixed, below a dew point. As it is possible to control the humidity of mixed air to a required humidity, it is possible to remove a variable by a change in humidity after outdoor air is mixed with circulating air.

Indoor pipes 238, 230, 234 may extend from pipes of the outdoor unit A and may be defined as refrigerant pipes in which refrigerant flows after flowing through the outdoor unit valves 130a, 134a, 138a. Depending on a mode of the indoor unit B and the outdoor unit A, gas state refrigerant with high or low pressure may flow in the first indoor gas line pipe 238.

The first indoor gas line pipe 238 may extend from the first gas line connection pipe 139 of the outdoor unit A and may be defined as a refrigerant pipe in which refrigerant flows from the first gas line valve 138a to the indoor unit B. Depending on the mode of the indoor unit B and the outdoor unit A, gas state refrigerant with high or low pressure flows in a second indoor gas line pipe 230.

The second indoor gas line pipe 230 may extend from the second gas line connection pipe 130 of the outdoor unit A and may be defined as a refrigerant pipe in which refrigerant flows from the second gas line valve 130a to the indoor unit B. Liquid state refrigerant switches a flow direction thereof, depending on the mode of the indoor unit B and the outdoor unit A, in the first indoor liquid line pipe 234.

Main coil 13 may be connected with the first indoor liquid line pipe 234 and the second indoor gas line pipe 230 and circulate refrigerant from the outdoor unit A. Sub coil 14, that heats or cools dehumidified mixed air, may be installed at a rear end of the main coil 13.

The sub coil 14 performs heat exchange while changing mode to reduce or to increase a temperature of dehumidified mixed air with the target humidity to the set target temperature. The sub coil 14 may be connected with the second indoor liquid line pipe 235 and the first indoor gas line pipe 238 and circulate refrigerant from the outdoor unit A. Thus, without installing a cooling unit or a heating unit, it is possible to cool or to heat by one sub coil 14 by adjusting the temperature of the refrigerant.

The indoor unit B is designed to maintain a constant temperature and a constant humidity by providing mixed air with the set target humidity and the set target temperature, through air discharge hole 18, to an interior. The air discharge hole 18 and air suction holes 16, 17 may be a duct type. A pressure chamber 11 may be formed to have an air supply hole that supplies indoors an air current dehumidified and cooled or heated at the thermo-hygrostat indoor unit B. A chamber with a nozzle may be formed at a first side and a second side of the pressure chamber 11 and may be formed to pressurize and discharge air dehumidified and cooled or heated toward the interior. The pressure chamber 11, as shown, may be formed at a region at which the outdoor air and indoor circulating air are introduced and mixed; however, embodiments are not limited thereto and it may be formed at a rear end of the sub coil.

A humidification unit that increases humidity or a filter unit that again filters discharged air may be provided when the humidity of the outdoor air at the rear end of the sub coil 14 is too low; however, embodiments are not limited thereto.

A temperature-humidity sensors 19, 20, 21 may be formed at the outdoor air suction hole 16, the indoor circulation air suction hole 17, and the air discharge hole 18, respectively. More specifically, first temperature-humidity sensor 19 may be formed outside of the outdoor air suction hole 16, second temperature-humidity sensor 20 may be formed outside of the indoor circulation air suction hole 17, third temperature-humidity sensor 21 may be formed adjacent to the air discharge hole 18 and outside of the case of the indoor unit B.

Each temperature-humidity sensors 19, 20, 21 may measure the temperature and the humidity and be manufactured as one module. Alternatively, a temperature sensor and a humidity sensor may be manufactured separately and disposed at each inlet and outlet. The temperature-humidity sensors 19, 20, 21 sense the temperature and the humidity at their position and send it as a sensing signal to a control unit.

The thermo-hygrostat air conditioner 100 further includes the valve C between the outdoor unit A and the indoor unit B. The valve C may include the first indoor gas line pipe 238 at a rear end of the first gas line valve 138a to which the first gas line connection pipe is connected, the second indoor gas line pipe 230 at a rear end of the second gas line valve 130a to which the second gas line connection pipe is connected, the first indoor liquid line pipe 234 at a rear end of the liquid line valve 134a to which the liquid line connection pipe 134 is connected, and the second indoor liquid line pipe 234 branched from the first indoor liquid line pipe 234.

The first indoor gas line pipe 238 of the valve C may be connected with the sub coil 14 so that gas state refrigerant flows therein, and the second indoor gas line pipe 230 may be connected with the main coil 13 so that gas state refrigerant flows therein. In this case, an indoor bypass pipe 237 that provides a bypass between the first indoor gas line pipe 238 and the second indoor gas line pipe 230 may be provided.

When the main coil 13 operates in the heating mode, that is, when the main coil operates in the heating mode so that the main coil 13 works as the condenser, the indoor bypass pipe 237 may bypass refrigerant flowing in the first indoor gas line pipe 238 to the main coil 13. For this bypass, an indoor bypass valve 25 may be installed on the indoor bypass pipe 237.

The indoor bypass valve 25 may bypass refrigerant in the first indoor gas line pipe 238 to the second indoor gas line pipe 230 or block a connection of two pipes 238, 230 by being on/off according to a mode of the main coil 13. Indoor gas line valve 24, interworking with the indoor bypass valve 25, may be installed at the second indoor gas line valve 230. The indoor gas line valve 24, on the second indoor gas line pipe 230, may be installed between the second gas line valve 130a and the indoor bypass pipe 237.

The indoor gas line valve 24 may be turned off when the indoor bypass valve 25 is turned on, and the indoor gas line valve 24 may be turned on, when the indoor bypass valve is turned off, so that only refrigerant flowing in one pipe between the first gas line connection pipe 138 or the second gas line connection pipe 130 flows selectively to the second indoor gas line pipe 230.

The indoor bypass valve 25 and the indoor gas line valve 24 may be two way valves and may operate only in on/off modes. For example, the indoor bypass valve 25 and the indoor gas line valve 24 may be a solenoid valve; however, embodiments are not limited thereto.

The first indoor liquid line pipe 234 may be branched to the second indoor liquid line pipe 235 in the valve C so that liquid state refrigerant flows into the sub coil 14. A main coil expansion valve 12 that expands and discharges liquid state refrigerant from the first indoor liquid line pipe 234 to the main coil 13 or that discharges liquid state refrigerant from the main coil 13 may be provided. A sub coil expansion valve 22 that expands and discharges liquid state refrigerant from the second indoor liquid line pipe 235 to the sub coil 14 or that discharges liquid state refrigerant from the sub coil 14 may be provided.

In this case, the main coil expansion valve 12 is installed between the main coil 13 and a sub liquid line pipe 235.

The main coil expansion valve 12 and the sub coil expansion valve 22 may expand liquid refrigerant which flows to each heat exchanger by controlling a degree of opening or may discharge liquid state refrigerant discharged from the heat exchanger without controlling the degree of opening. In this case, it is possible to realize via an electronic expansion valve variable flow of refrigerant depending on a control thereof; however, embodiments are not limited thereto.

Further, the valve C as two two-way valves 24, 25 and the two expansion valves 12, 22; however, the valve C may be in the indoor unit B together and embodiments are not limited thereto.

The thermo-hygrostat indoor unit B may further include a controller that receives a control command and the sensing signal from the outside, and delivers it to the outdoor unit A by wired or wireless communication. It is possible to perform driving that provides air with a constant temperature and constant humidity indoors by cooling or heating indoor air, while simultaneously circulating refrigerant of two heat exchangers in the thermo-hygrostat indoor unit B connected by one simultaneous type outdoor unit A and remove latent heat of the outdoor air and provide it indoors.

The thermo-hygrostat air conditioner includes the control unit (not shown) that controls an operation of valve and the compressors 53, 54 such that two heat exchangers of the indoor unit B, that is, the main coil 13, the sub coil 14, and the outdoor heat exchangers A1, A2 of the outdoor unit A respectively operate with the changing mode depending on the temperature and the humidity of the indoor circulating air and discharged air. The control unit acquires the sensing signal from each temperature-humidity sensors 19, 20, 21, and determines a mode of each heat exchanger by comparing the set indoor target temperature and target humidity with the temperature and humidity of current air.

The control unit controls each valve such that each determined heat exchanger, that is, the outdoor heat exchangers A1, A2, and the main coil 13 and the sub coil 14 of the indoor unit B, operates as the condenser or the evaporator according to the mode thereof.

The control unit may be realized as one integrated circuit or may be formed as a module having a plurality of circuit chips. The mode control may be provided as an application, by being realized as an algorithm, conducted in a terminal of an administrator.

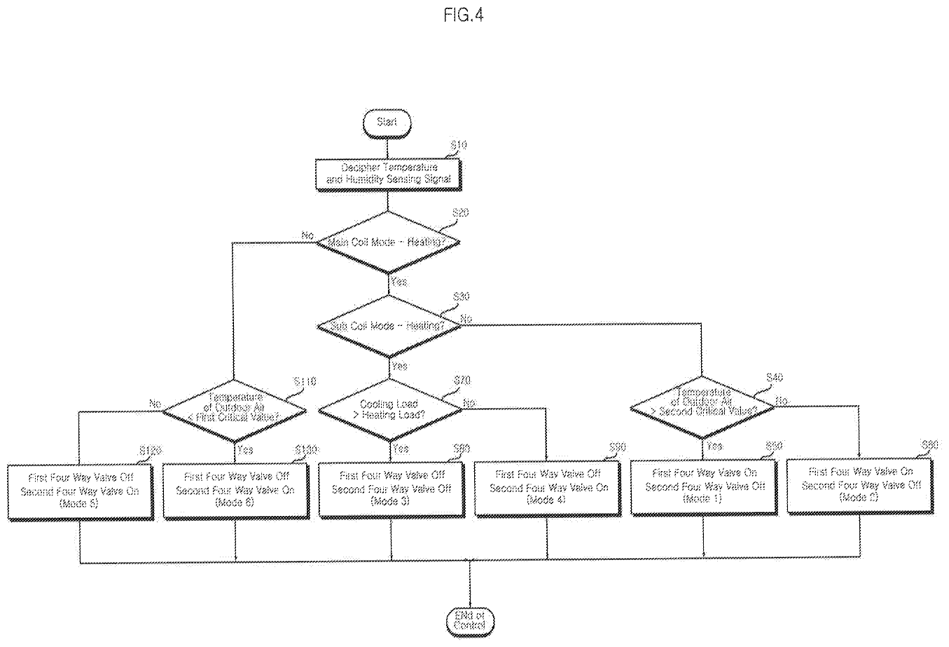

Hereinafter, referring to FIG. 4, the mode control of the thermo-hygrostat air conditioner 100 is described.

The modes that the current thermo-hygrostat air conditioner 100 can realize are shown in Table 1 below.

TABLE 1

| | Main Coil | Sub Coil | Indoor | Outdoor |
|---|---|---|---|---|
| Sort | Mode | Mode | Unit Load | Unit Load |
| Mode 1 | Cooling | Cooling | A Half of | Cooling |
| | | | Cooling Load | Leader |
| | | | or more | |
| Mode 2 | Cooling | off | A Half of | Cooling |
| | | | Cooling Load | Leader |
| | | | Or less | |
| Mode 3 | Cooling | Heating | Cooling Load > | Cooling |
| | | | Heating Load | Leader |
| Mode 4 | Cooling | Heating | Cooling Load < | Heating |
| | | | Heating Load | Leader |
| Mode 5 | off | Heating | A half of | Heating |
| | | | Heating Load | Leader |
| | | | or less | |
| Mode 6 | Heating | Heating | Above a half | Heating |
| | | | of Heating | Leader |
| | | | Load | |

When the main coil 13 or the sub coil 14 operate in the cooling mode, the main coil 13 or the sub coil 14 operate as the evaporator and dehumidify by condensing moisture of the outdoor air or operate indoor cooling. When the main coil 13 or the sub coil 14 operates in the heating mode, the main coil 13 or the sub coil 14 operate as the condenser and heat the interior by discharging heat to the mixed air.

When the main coil 13 or the sub coil 14 is in the off mode, when there is no dehumidification load, that is, if the current humidity is the same as the target humidity or there is no heating load, that is, it is defined that the current temperature is the same as the target temperature. In this case, in an outdoor unit mode, in the cooling leader mode, the outdoor unit heat exchangers A1, A2 operate as the condenser and discharge refrigerant so that the indoor unit B operates in cooling, and in heating leader mode, the outdoor unit heat exchangers A1, A2 operate as the evaporator and discharge refrigerant so that the indoor unit B operates in heating.

The thermo-hygrostat air conditioner 100 receives the temperature and humidity of the current indoor air, the target temperature and humidity, and the temperature and humidity of the outdoor air according to the sensing signals of each sensor 19, 20, 21 and calculates the cooling load and the heating load, respectively, and selects one mode among six modes in Table 1 according to the calculated cooling load and heating load S10. When the final mode is selected, the mode of each heat exchanger 13, 14, A1, A2 is selected according to that mode. Accordingly, opening and closing of the four way valves 110, 120 and the expansion valves 65, 67, 12, 22 are controlled.

More specifically, the controller determines that dehumidification should be performed by calculating a cooling load for dehumidification, and sets the main coil 13 to a cooling mode (S20) when the humidity of the outdoor air is higher than the target humidity by comparing the target humidity and the humidity of the outdoor air from the first temperature-humidity sensor 19 of the outdoor air suction hole 16. In this case, a humidity for calculating the load may be the absolute humidity of the relative humidity, and both are applicable.

When the main coil 13 is determined as the cooling mode, the control unit deciphers the temperature sensing signal from the temperature-humidity sensors 19, 20, 21 to determine the mode of the sub coil 14 (S30). When the heating load is determined from the deciphered sensing signal, that is, when a mixed temperature of the temperature of the indoor circulation air and the temperature of the outdoor air is lower than the target temperature, it is possible to determine there is the heating load.

In this case, when the sub coil 14 is not in the heating mode because of lack of the heating load, the mode of the sub coil 14 is eventually determined according to whether the temperature of the outdoor air is higher than a second critical value (S40). More specifically, when the temperature of the outdoor air is higher than the second critical value, by determining that the temperature of the outdoor air is so high that cooling is needed, the mode of the sub coil 14 is determined as the cooling mode and mode 1, such that both the main coil 13 and the sub coil 14 are in the cooling mode, is determined. According to the determination of mode 1, the outdoor unit A is set to the cooling leader mode so that the first four way valve 120 is on, and the second four way valve 110 is off, and then the outdoor heat exchangers A1, A2 operate as the condenser.

When the temperature of the outdoor air is lower than the second critical value, as the temperature of the outdoor air is not high, it is determined that additional cooling is not needed, by determining blocking heat exchange of sub coil 14, that is, determining off mode blocking refrigerant flowing into the sub coil 14, mode 2, such that the main coil 13 is in the cooling mode and the sub coil 14 is in the off mode, is eventually determined. According to the determination of the mode 2, the outdoor unit A is set to the cooling leader mode, and the first four way valve 120 is on, the second four way valve 110 is off, and the outdoor heat exchangers A1, A2 operate as the condenser.

The second critical value may be 20 degrees or more, more specifically 25 degrees or more, and even more specifically 27 degrees or more; however, embodiments are not limited thereto.

When the heating load of the sub coil 14 is for heating, the control unit compares the cooling load and the heating load of the main coil 13 with each other (S70). More specifically, it compares the cooling load of the main coil 13 for dehumidification with the heating load of the sub coil 14 for heating, and determines mode 3 when the cooling load is larger than the heating load (S80). According to the determination of the mode 3, the outdoor unit is set to the cooling leader mode, the first four way valve 120 is turned off, the second four way valve 110 is turned off, and the outdoor heat exchangers A1, A2 operate as the condenser.

In contrast, the control unit compares the cooling load of the main coil 13 for dehumidification and the heating load of the sub coil 14 for heating, and determines the mode 4 when the cooling load is smaller than the heating load (S90). According to the determination of the mode 4, the outdoor unit A is set to the heating mode, the first four way valve 120 is turned off, the second four way valve 110 is turned on, and the outdoor heat exchangers A1, A2 operate as the evaporator.

When the mode of the main coil 13 is not cooling due to absence of the cooling load for dehumidification, the control unit determines whether the temperature of the outdoor air is smaller than the first critical value (S110). The first critical value is a value for determining whether the main coil 13 has to be operated in the heating mode because the temperature of the outdoor air is too low, for example, it may be 5 degrees to 15 degrees, for example, 10 degrees; however, embodiments are not limited thereto.

When the temperature of the outdoor air is not lower than the first critical value, the control unit determines mode 5, in which the main coil 13 operates in the off mode and the sub coil 14 operates in the heating mode, by determining the heating load is not large (S120). According to the determination of mode 5, the outdoor unit A is set to the heating leader mode, the first four way valve 120 is turned off, the second four way valve 110 is turned on, and the heat exchangers A1, A2 operate as the evaporator.

When the temperature of the outdoor air is lower than the first critical value, the control unit determines the mode 6, in which the main coil 13 operates in the heating mode and the sub coil 14 also operates in the heating mode, by determining the heating load is very large. According to the determination of mode 6, the outdoor unit A is set to the heating leader mode, the first four way valve 120 is turned off, the second four way valve 110 is turned on, and the outdoor heat exchangers A1, A2 operate in evaporator.

According to the control logics above, the control unit selects one among six modes finally determined and may operate each valve and compressor.

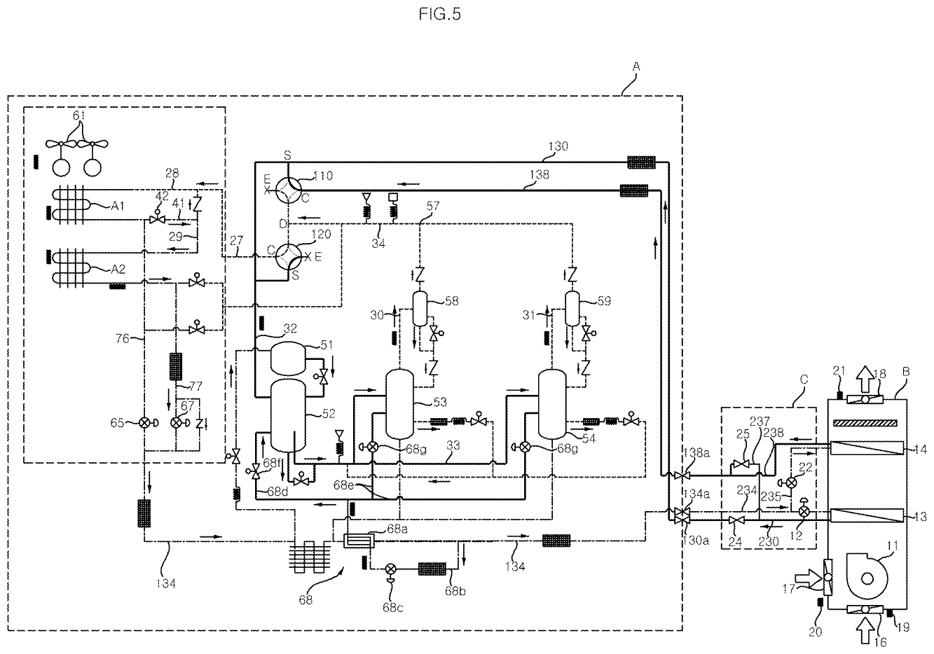

Hereinafter, referring to FIGS. 5 to 9, circulation of refrigerant and operation of each valve of the thermo-hygrostat air conditioner at each mode are described.

FIG. 5 is an operation diagram showing circulation of refrigerant in mode 1 and mode 2 of FIG. 4.

Opened and closes states of the first and the second four way valves 120, 110 of the outdoor unit A in the mode 1 and mode 2 are maintained. That is, the first four way valve 120 is maintained in the on state, and the second four way valve 110 is maintained in the off state.

In mode 1, when both the main coil 13 and the sub coil 14 of the indoor unit B perform the cooling mode, the compressed refrigerant, with high temperature and high pressure, of the compressors 54, 54 flows into the outdoor heat exchangers A1, A2 and is further condensed. The first four way valve 110 is set to the on state such that refrigerant discharged from the compressors 53, 54 does not pass through the first four way valve 110. The second four way valve 120 is set to the on state such that refrigerant discharged from the compressors 53, 54 passes through the second four way valve 120. That is, the second four way valve 120 connects the compressor discharge pipe 34 and the outdoor heat exchanger-first four way valve connection pipe 27. Accumulator inflow pipe 32 is branched to the second gas line connection pipe 130, and a portion of refrigerant flows into the accumulator inflow pipe 32 through the second gas line connection pipe 130.

In mode 1, the gas line valve 134a, and the first gas line connection pipe and the second gas line connection pipe 138a, 130a are also opened. In the valve C, the indoor gas line valve 24 is opened and connects the second gas line connection pipe 130 and the second indoor gas line pipe 230, and the indoor bypass valve 25 is closed and connects the first gas line connection pipe 138 and the first indoor gas line pipe 238 and discharges refrigerant.

Explaining the flow of refrigerant, refrigerant discharged from the compressors 53, 54 flows into the outdoor heat exchangers A1, A2 through the second four way valve 120. Refrigerant condensed in the outdoor heat exchangers A1, A2 flows through the liquid line connection pipe 134 via the valve C and flows into the indoor liquid line pipe 234 of the indoor unit B and branches to the second indoor liquid line pipe 235 and evaporates at the main coil 13 and the sub coil 14 by the degree of opening of the main coil expansion valve 12 and the sub coil expansion valve 22, gaseous refrigerant evaporated while passing through the main coil 13 flows into the second has line connection pipe 131 via the second indoor gas line pipe 230. Refrigerant flowing into the second gas line connection pipe 131 flows into the compressors 53, 54 via the accumulator 52.

In this case, gaseous refrigerant evaporated while passing through the sub coil 14 flows into the first indoor gas line pipe 238 and flows into the first gas line connection pipe 138. Refrigerant flowing into the first gas line connection pipe 138 flows into the compressors 53, 54 via the accumulator 52.

As the one simultaneous type outdoor unit A may dehumidify the outdoor air while refrigerant is evaporated in the main coil 13 and may cool and supply the mixed dehumidified air while refrigerant is evaporated in the sub coil 14, it is possible to maximize cooling capacity and to improve cooling performance.

In mode 2, when the main coil 13 of the outdoor unit B is in the cooling mode and the sub coil 14 is in the off mode, opening and closing of the valve may be same as in FIG. 5; however, liquid refrigerant does not flow into the second indoor liquid line pipe 235. Refrigerant may flow into the second indoor liquid line pipe 235, in a state that does affect the cycle, without retention by opening the sub coil expansion valve 22 a little to prevent ponding.

More specifically, the first four way valve 110 is set to the on state such that refrigerant discharged from the compressors 53, 54 does not pass through the first four way valve 110. The second four way valve 120 is set to the off state such that refrigerant discharged from the compressors 53, 54 passes through the second four way valve 120. That is, the second four way valve 120 connects the compressor discharge pipe 34 and the outdoor heat exchanger-first four way valve connection pipe 27. The accumulator inflow pipe 32 is branched to the second gas line connection pipe 130, and a portion of refrigerant flows into the accumulator inflow pipe 32 via the second gas line connection pipe 130.

In mode 2, the liquid line valve 134a, the first gas line connection pipe valve, and the second gas line connection pipe valve 138a, 130a are opened. In the valve C, the indoor gas line valve 24 is opened and connects the second gas line connection pipe 130 and the second indoor gas line pipe 230, the indoor bypass valve 25 is closed and does not bypass refrigerant in the first indoor gas line pipe 238 into the second indoor gas line pipe 230, and refrigerant flows by connecting the first gas line connection pipe 138 and the first indoor gas line pipe 238.

Refrigerant discharged from the compressors 53, 54 flows into the outdoor heat exchangers A1, A2 via the second four way valve 120. Refrigerant condensed in the outdoor heat exchangers A1, A2 passes through the liquid line connection pipe 134, via the valve C, and flows into the indoor liquid line pipe 234, but liquid state refrigerant only flows into the main coil 13 without being branched to the second indoor liquid line pipe 235 by closing the sub coil expansion valve 22. Hence, expanded liquid refrigerant passes through the main coil 13 and evaporates, evaporated gaseous refrigerant flows into the second indoor gas line pipe 230 and flows into the second gas line connection pipe 131. Refrigerant flowing into the second gas line connection pipe 131 flows into the compressors 53, 54 via the accumulator 52.

In this case, although there is no flow of refrigerant that passes through the sub coil 14, it is possible to open the valve 22 such that the first indoor gas line pipe 238 and the first gas line connection pipe 138 are connected to prevent ponding.

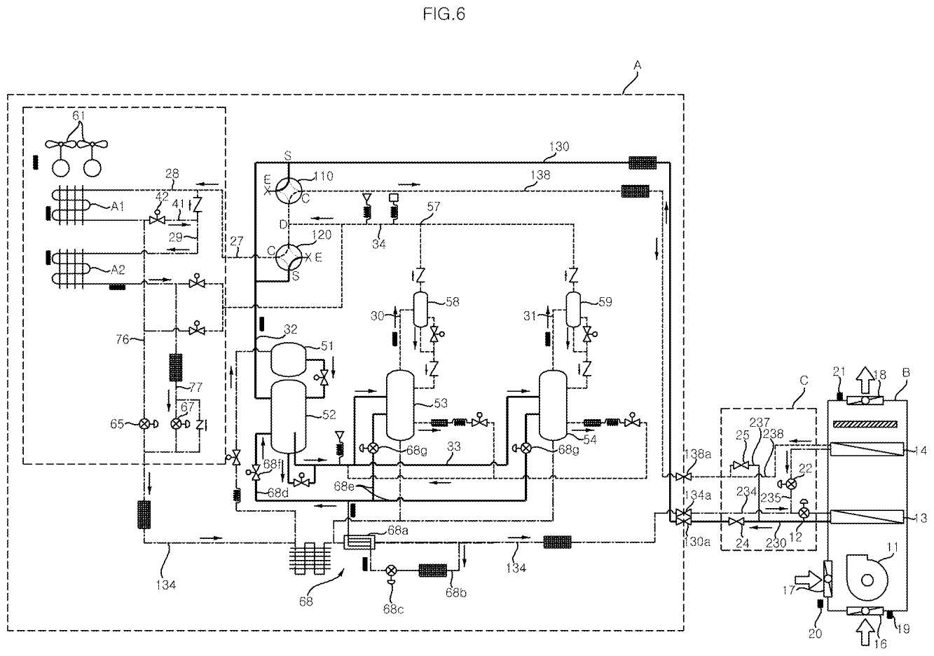

FIG. 6 is an operation diagram showing circulation of refrigerant in mode 3 of FIG. 4.

In the mode 3, the first four way valve 120 is maintained in the off state, and the second four way valve 110 is maintained in the off state. That is, the main coil 13 of the outdoor unit B is in the cooling mode and the sub coil 14 is in the heating mode, but the outdoor unit A operates in the cooling mode and the outdoor heat exchangers A1, A2 operate as the condenser when the cooling load is larger than the heating load. Hence, compressed refrigerant with high temperature and high pressure in the compressors 53, 54 is further condensed by flowing through the outdoor heat exchangers A1, A2.

The first four way valve 110 is set to the off state such that refrigerant discharged from the compressors 53, 54 passes through the first four way valve 110, and the second four way valve 120 is also set to the off state such that refrigerant discharged from the compressors 53, 54 passes through the second four way valve 120. That is, the first four way valve 110 connects the compressor discharge pipe 34 and the first gas line connection pipe 138, and the second four way valve 120 connects the compressor discharge pipe 34 and the outdoor heat exchanger-first four way valve connection pipe 27. The accumulator inflow pipe 32 is branched to the second gas line connection pipe 130, and a portion of refrigerant flows into the accumulator inflow pipe 32 via the second gas line connection pipe 130.

In mode 3, the liquid line valve 134a, the first has line connection pipe valve 138a, and the second gas line connection pipe valve 130a are opened. In the valve C, indoor gas line valve 24 is opened and connects the second gas line connection pipe 130 and the second indoor gas line pipe 230 with each other, and the indoor bypass valve 25 is closed and does not bypass refrigerant in the first indoor gas line pipe 238 to the second indoor gas line pipe 230, and refrigerant flows by connecting the first gas line connection pipe 138 and the first indoor gas line pipe 238.

Explaining the flow of refrigerant, refrigerant discharged from the compressors 53, 54 flows into the outdoor heat exchangers A1, A2 via the second four way valve 120. Refrigerant condensed in the outdoor heat exchangers A1, A2 passes through the liquid line connection pipe 134 and flows into the indoor liquid line pipe 234 of the indoor unit B via the valve C and is evaporated in the main coil 13 by the degree of opening of the main coil expansion valve 12.

Evaporated gaseous refrigerant after passing through the main coil 13 flows into the second indoor gas line pipe 230 and flows into the second gas line connection pipe 131. Refrigerant flowing into the second gas line connection pipe 131 flows into the compressors 53, 54 via the accumulator 52.

In this case, a portion of refrigerant discharged from the compressors 53, 54 flows into the first gas line connection pipe 138 via the first four way valve 110. Compressed gaseous refrigerant flowing into the first indoor gas line pipe 238 of the indoor unit B via the first gas line connection pipe 138 is condensed at the sub coil 14 and heats the mixed air. Liquid refrigerant condensed at the sub coil 14 joins with the indoor liquid line pipe 234, through the second indoor liquid line pipe 235, and flows into the main coil 13.

That is, liquid refrigerant evaporated at the main coil 13 is defined as a mixed refrigerant of liquid refrigerant condensed at the outdoor unit A and liquid refrigerant condensed at the sub coil 14. In this case, the main coil expansion valve 12 performs opening for expansion of refrigerant, and the sub coil expansion valve 22 is fully opened for flow of refrigerant.

The thermo-hygrostat air conditioner 100 is provided by changing the flow of refrigerant such that the main coil 13 operates in the cooling mode and the sub coil 14 operates in the heating mode by the one simultaneous type outdoor unit A. In addition, thermal efficiency is improved by improving the heating of the sub coil 14, that is, reheating air by collecting waste heat from the main coil 13.

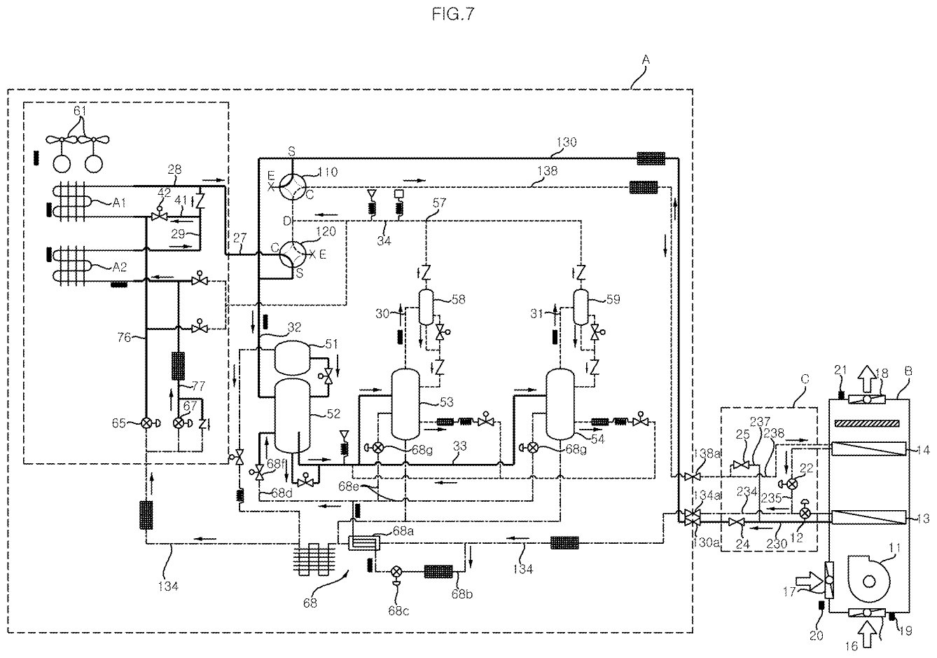

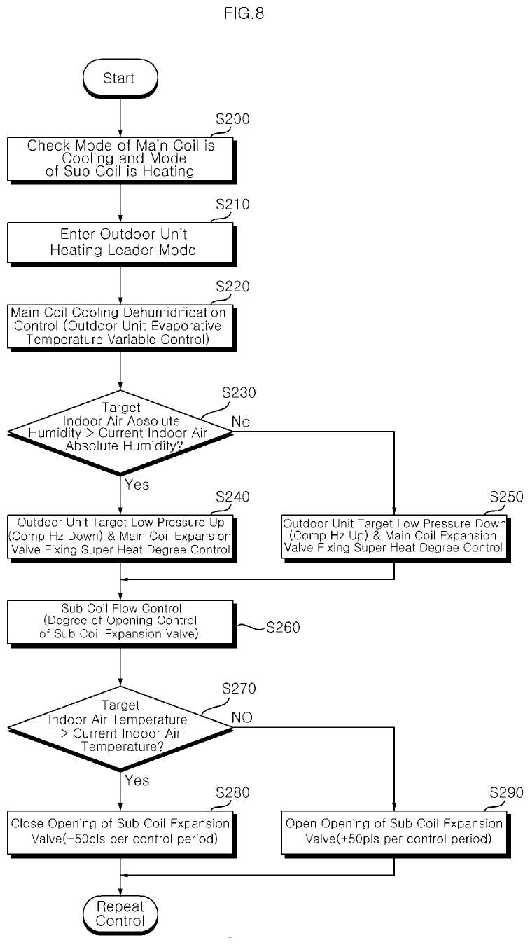

FIG. 7 is an operation diagram showing circulation of refrigerant in mode 4 and mode 5 of FIG. 4. FIG. 8 is a flow chart of a method for controlling a degree of opening of each expansion valve of a valve in mode 4 of FIG. 7.

In mode 4, the first four way valve 120 is maintained in the off state, and the second four way valve 110 is maintained in the on state. That is, the main coil 13 of the indoor unit B is in the cooling mode, the sub coil 14 is in the heating mode, but the outdoor unit A operates in the heating leader mode and the outdoor heat exchangers A1, A2 operate as the evaporator when the cooling load is smaller than the heating load.

The first four way valve 110 is set to the off state such that refrigerant discharged from the compressors 53, 54 passes through the first four way valve 110, and the second four way valve 120 is set to the on state such that refrigerant discharged from the compressors 53, 54 does not pass through the second four way valve 120. That is, the first four way valve 110 connects the compressors 53, 54 and the first gas line connection pipe 138. The second four way valve 120 connects the outdoor heat exchanger-first four way valve connection pipe 27 such that refrigerant discharged from the outdoor heat exchangers A1, A2 flows into the compressors 53, 54 via a first accumulator 52. The accumulator inflow pipe 32 is branched to the second gas line connection pipe 130 and a portion of refrigerant from the main coil 13 of the indoor unit flows into the accumulator inflow pipe 32 through the second gas line connection pipe 130.

In mode 4, the liquid line valve and the first and the second gas line valve 134a, 138a, 130a are also opened.

In the valve C, the indoor gas line valve 24 is opened and connects the second gas line connection pipe 130 and the second indoor gas line valve 230 with each other, the indoor bypass valve 25 is closed so that refrigerant in the first indoor gas line pipe 238 does not bypass into the second indoor gas line pipe 230, and refrigerant flows by connecting the first gas line connection pipe 138 and the first indoor gas line pipe 238.

Explaining the flow of refrigerant, refrigerant discharged from the compressors 53, 54 flows into the first gas line connection pipe 138 through the first four way valve 110. Refrigerant flowing in the first gas line connection pipe 138 flows into the indoor unit B, and is condensed in the sub coil 14. Refrigerant condensed in the sub coil 14 flows into the outdoor unit A through the liquid line connection pipe 134 via the second indoor liquid line pipe 235. Refrigerant introduced into the outdoor unit A flows into the outdoor heat exchangers A1, A2 through the outdoor expansion valves 65, 66. Refrigerant evaporated in the outdoor heat exchangers A1, A2 flows into the second four way valve 120, and flows into the compressors 53, 54 through the first accumulator 52.

In this case, refrigerant condensed at the sub coil 14 of the indoor unit B, via the first indoor liquid line pipe 234 from which the second indoor liquid line pipe 235 is branched, flows into the main coil 13 and evaporates at the main coil 13 and performs dehumidification by removing the latent heat of the outdoor air. Evaporated refrigerant flows into the first indoor gas line pipe 238 and into the second gas line connection pipe 130. Refrigerant flowing into the second gas line connection pipe 130 flows into the first and second compressors 53, 54 via the first accumulator 52.

Thus, in mode 4, refrigerant compressed for dehumidifying moisture in the outdoor air, by inducing liquid refrigerant generated at the sub coil 14 of the indoor unit B to flow again into the main coil 13, is performed. That is, in mode 4, when the heating load is larger than the cooling load, it is possible to provide the sub coil 14 with a sufficient quantity of reheating that is required to operate the outdoor heat exchangers A1, A2 as the evaporator by changing the mode of the outdoor unit A to the heating leader mode. Hence, when the quantity of reheating is required more like a conventional mode 4, it is possible to provide a sufficient quantity of reheating without an additional heater or module such as steam.

In mode 3 and mode 4, the mode of the main coil 13 and that of the sub coil 14 are actually the same, but the mode of the outdoor unit A is determined depending on the difference in size between the cooling load and the heating load. That is, when the cooling load for dehumidification is larger, the outdoor unit A operates as the condenser, and when the heating load for reheating is larger, the outdoor unit A operates as the evaporator.

According to the heating load and cooling load, the control unit is capable of linear control by controlling the degree of opening of sub coil expansion valve 22 and by controlling the outdoor unit. For example, in mode 4, as shown in FIG. 8, it performs a control of a quantity of heat depending on the temperature and humidity which are variable in real time while performing the control of the degree of opening of the sub coil expansion valve 22.

First, if it is checked that the main coil 13 is in the cooling mode and the sub coil 14 is in the heating mode, and mode 4 is confirmed by comparing the heating load and the cooling load depending on the current humidity and temperature, the outdoor unit A enters the heating leader mode (S210). As the mode of the outdoor unit A is hard to change in one circulation, it is possible to control the heating load and the cooling load of the main coil 13 and the sub coil 14 according to the humidity and temperature which are steadily variable, from an initial mode, without changing the on/off state of the first and second four way valves 110, 120.

More specifically, an initial mode of the outdoor unit A is the heating leader mode in which the first four way valve 120 is in the off state to operate as the evaporator and the second four way valve 110 is maintained in the on state, accordingly refrigerant flows. In this case, the control unit may perform target low pressure control of the outdoor unit A, not the control of the degree of opening of expansion valve of the main coil 13 for cooling dehumidification control of the main coil 13.

More specifically, the control unit receives sensed information for the absolute humidity by measuring the absolute humidity of current indoor air (S230). When the absolute humidity of the current indoor air is lower than target absolute humidity of the indoor air, it is determined that the absolute humidity indoors is not sufficient, and a control may be performed that reduces the cooling load for dehumidification (S240).

The control reducing the cooling load increases a target low pressure of the compressors 53, 54 of the outdoor unit A, and may lower a drive frequency of the compressors 53, 54. In this case, the main coil expansion valve 12 performs a fixed overheat degree control, and the quantity of heat of evaporation at the main coil 13 decreases because the compression ratio decreases by increasing the target low pressure of the outdoor unit A.

When the absolute humidity of the current indoor air is not lower than the target absolute humidity of the indoor air, it is determined that the absolute humidity indoors is sufficient, and may perform a control increasing a quantity of cooling for dehumidification (S250). The control increasing the quantity of cooling reduces the target low pressure of the compressors 53, 54 of the outdoor unit A, and it is possible to increase a frequency of the compressors 53, 54. In this case, as it is possible to control a total amount of the quantity of heat of evaporation of the main coil 13 and the outdoor heat exchangers A1, A2 driving as the evaporator at an outdoor unit A side by performing the fixing super heat degree control of the main coil expansion valve 12, a control of the quantity of heat of evaporation may be done linearly.

As the sub coil 14 operates as the condenser in the heating mode, a control of reheating load is possible by controlling a rate of flow of refrigerant inserted into the sub coil 14 which is a reheating coil (S260). That is, the control unit receives the sensed information of the temperature of the indoor air and compares a target temperature of the indoor air with the temperature of current indoor air (S270).

In this case, when the temperature of current indoor air is lower than the target temperature of indoor air, the reheating load is secured by decreasing the degree of opening of the sub coil 14. Hence, it is possible to heat the indoor air further, and the decrease in the degree of opening may be 50 pls per control period; however, embodiments are not limited thereto (S280).

When the temperature of current indoor air is not lower than the target temperature of indoor air, the reheating load may be decreased by increasing the degree of opening of reheating coil. Hence, it is possible to decrease heating of the indoor air, and the increase in the degree of opening may be 50 pls per control period; however, embodiments are not limited thereto (S290). But, when a certain time has elapsed while the temperature of current indoor air is larger than the target temperature of indoor air, it is deemed that there is no heating load, and realizes the sub coil 14 is in the off mode and be able to change to mode 2 while the whole air conditioning system is stopped.

In FIG. 8, limited to mode 4, a load control of the main coil 13 and the sub coil 14 is described, but in mode 3, in contrast to FIG. 8, as the heating load is smaller than the cooling load, a cooling load control of the main coil 13 which operates as the evaporator may performed by a target high pressure control of the compressors 53, 54 of the outdoor unit A which operates as the condenser. In addition, a heating load control of the sub coil 14, which operates as the condenser, may be performed by the sub coil expansion valve 22, as shown in FIG. 8.

It is possible to control to balance between the quantity of heat of evaporation in the entire cycle and the quantity of heat of condensation; however, embodiments are not limited thereto.

Again, returning to FIG. 7, in mode 5, the first four way valve 120 is maintained in the off state like mode 4, and the second four way valve 110 is maintained in the on state. That is, the main coil 13 of the indoor unit B is in the off mode, the outdoor unit A operates in the heating mode when the sub coil 14 operates in the heating mode, the outdoor heat exchangers A1, A2 operate as the evaporator.

The first four way valve 110 is set to the off state such that refrigerant discharged from the compressors 53, 54 passes through the first four way valve 110, and the second four way valve 120 is set to the on state such that refrigerant discharged from the compressors 53, 54 does not pass the second four way valve 120. That is, the first four way valve 110 connects the compressors 53, 54 and the first gas line connection pipe 138. The second four way valve 120 connects the outdoor heat exchanger-first four way valve connection pipe 27 and the accumulator inflow pipe 32 such that refrigerant discharged from the outdoor heat exchangers A1, A2 flows into the compressors 53, 54 via the first accumulator 52. The first four way valve 110 provides refrigerant discharged from the compressors 53, 54 to the first gas line connection pipe 138 connected with the indoor unit B.

The accumulator inflow pipe 32 is branched to the second gas line connection pipe 130, and a portion of refrigerant from the main coil 13 of the indoor unit flows into the accumulator inflow pipe 32 via the second gas line connection pipe 130. In the valve C, the indoor gas line valve 24 is opened and connects the second gas line connection pipe 130 and the second indoor gas line pipe 230 with each other. The indoor bypass valve 25 is closed and does not bypass refrigerant in the indoor gas line pipe 238 to the second indoor gas line pipe 230, and refrigerant flows by connecting the first gas line connection pipe 138 and the first indoor gas line pipe 238.

Explaining flow of refrigerant, refrigerant discharged from the compressors 53, 54 flows into the first gas line connection pipe 138 through the first four way valve 110. Refrigerant flowing in the first gas line connection pipe 138 flows into the indoor unit B, and is condensed at the sub coil 14. Refrigerant condensed at the sub coil 14 flows into the outdoor unit A through the second indoor liquid line pipe 235 via the liquid line connection pipe 134. Refrigerant introduced into the outdoor unit A flows into the outdoor heat exchangers A1, A2 via the outdoor expansion valves 65, 66. Refrigerant evaporated at the outdoor heat exchangers A1, A2 flows to the second four way valve 120, and flows to the compressors 53, 54 via the first accumulator 52.

In this case, refrigerant condensed at the sub coil 14 of the indoor unit B flows into the main coil 13 through the first indoor liquid line pipe 234 from which the second indoor liquid line pipe 235 is branched, but actually as the main coil 13 is in the off mode, the degree of opening of the main coil expansion valve 12 is set to very small so as to prevent ponding. Hence, heat exchange at the main coil 13 is not sufficient to generate dehumidification, but liquid refrigerant flows to the first indoor gas line pipe 238 and flows to the second gas line connection pipe 130. Refrigerant flowing into the second gas line connection pipe 130 flows into the compressors 53, 54 via the first accumulator 52.

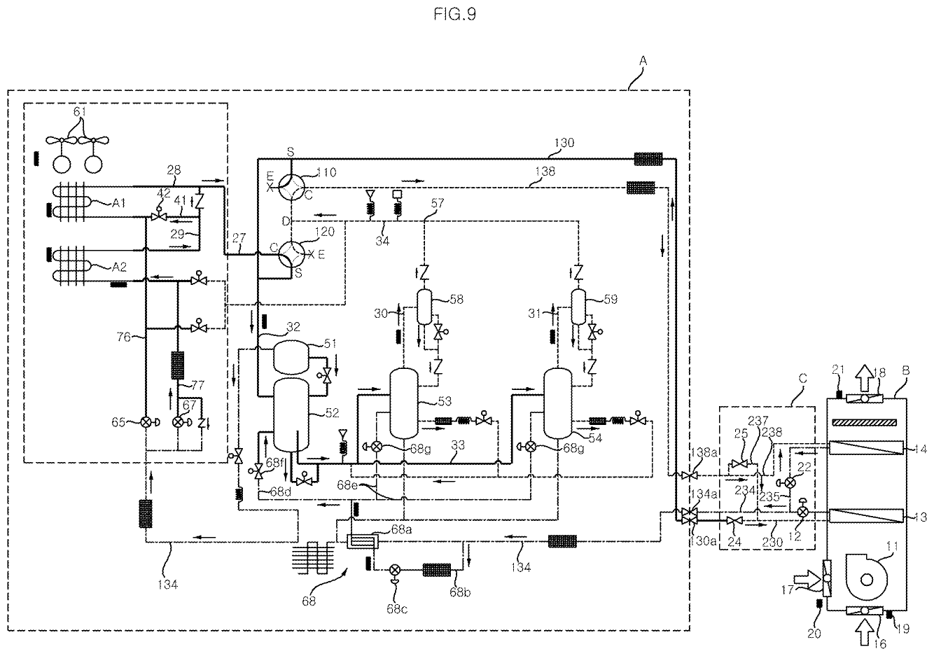

FIG. 9 is an operation diagram showing circulation of refrigerant in mode 6 of FIG. 4. In mode 6, like mode 4, the first four way valve 120 is maintained in the off state and the second four way valve 110 is maintained in the on state. That is, when the main coil 13 of the indoor unit B is in the heating mode and the sub coil 14 is in the heating mode, the outdoor unit A operates in the heating mode and the outdoor heat exchangers A1, A2 operate as the evaporator.

The first four way valve 110 is set to the off state such that refrigerant discharged from the compressors 53, 54 passes through the first four way valve 110, and the second four way valve 120 is set to the on state such that refrigerant discharged from the compressors 53, 54 does not pass through the second four way valve 120. That is, the first four way valve 110 connects the compressors 53, 54 and the first gas line connection pipe 138. The second four way valve 120 connects the outdoor heat exchanger-first four way valve connection pipe 27 and the accumulator inflow pipe 32 such that refrigerant discharged from the outdoor heat exchangers A1, A2 flows to the compressors 53, 54 via the first accumulator 52. The first four way valve 110 provides refrigerant discharged from the compressors 53, 54 to the first gas line connection pipe 138 which is connected with the indoor unit B.

In the valve C, the second gas line connection pipe 130 and the second indoor gas line pipe 230 are not connected to each other by closing the indoor gas line valve 24. Refrigerant in the first indoor gas line pipe 238 bypasses to the second indoor gas line pipe 230 via the bypass pipe 237 by opening the indoor bypass valve 25, and refrigerant in the first gas line connection pipe 138 flows to both the first indoor gas line pipe 238 and the second indoor gas line pipe 230. That is, the indoor gas line valve 24 and the indoor bypass valve 25 operate exclusively with each other and are controlled such that only refrigerant from one gas line connection pipe 138, 130 flows in the second indoor gas line pipe 230.

Explaining the flow of refrigerant, refrigerant discharged from the compressors 53, 54 flow to the first gas line connection pipe 138 through the first four way valve 110. Refrigerant flowing in the first gas line connection pipe 138 flows into the indoor unit B and is condensed at the sub coil 14 and the main coil 13. Refrigerant condensed at the sub coil 14 and the main coil 13 flows into the outdoor unit A through the second indoor liquid line pipe 235 and the first indoor liquid line pipe 234 via the liquid line connection pipe 134. Refrigerant introduced into the outdoor unit A flows to the outdoor heat exchangers A1, A2 through the outdoor expansion valve 65, 66. Refrigerant evaporated at the outdoor heat exchangers A1, A2 flows into the second four way valve 120 and flows into the compressors 53, 54 via the first accumulator 52.

When dehumidification is not required at all, the main coil 13 may also operate as the condenser, for heating the indoor air, like the sub coil 14 when the heating load is too large so that the quantity of reheating is very large.

Conventionally, a simultaneous heating of the main coil 13 and the sub coil 14 was impossible, but it is possible to realize it in the embodiments disclosed herein by including the bypass pipe 237 and the valve 25, in the indoor unit B, between the main coil 13 and the sub coil 14. When the thermo-hygrostat indoor unit B including the main coil 13 for dehumidification and the sub coil 14 for reheating is driven, all possible combinations of modes are possible without a separate additional facility, for example, a reheat module, such as a heater or steam.

With the embodiments disclosed herein, it is possible to operate the main coil (cooling) and the reheating coil (heating) in various cycles by one outdoor unit without a separate control unit of refrigerant flow (heat recovery unit). In particular, it is possible to make up the cycle such that the drive modes of the main coil and the reheating mode of the indoor unit may be adjusted freely to the cooling/heating mode and it is possible to drive a stable cycle.

In addition, efficiency for the cooling operation may be improved by driving the reheating coil in the cooling mode, when the cooling load is large. Also, it is possible to increase the efficiency of collecting waste heat by switching and controlling the mode of the outdoor unit to the cooling leader of the heating leader and to realize the driving mode of the outdoor unit in various ways, when the main coil operates in cooling and the reheating coil operates in heating.

When the heating load, based on the temperature and humidity which are measured, is very high, a quantity of reheating is secured by the main coil, a volume of heat exchanger used as the condenser increases, and a high pressure of the system for reaching a target during the heating operation decreases, eventually the drive efficiency may increase.

Finally, it is possible to drive in the heating mode without heating equipment, such as an electric heater and steam for additional reheating control and it is possible to minimize the use of a valve and pipe while it is controlled in various ways.

Embodiments disclosed herein provide a thermo-hygrostat air conditioner capable of driving various cycles of a main coil (for dehumidification) and a reheating coil (for heating) with one outdoor unit without a separate control unit of refrigerant flow (heat recovery unit). Embodiments disclosed herein make up a cycle driving mode of the main coil and the reheating coil to freely adjust to the cooling/heating mode and to provide a thermo-hygrostat air conditioner capable of driving a stable cycle.

Embodiments disclosed herein provide an air conditioner capable of improving efficiency of cooling driving by operating the reheating coil in the cooling mode when a cooling load is large. Embodiments disclosed herein provide an air conditioner capable of realizing a drive mode of the outdoor unit in various ways such that efficiency of waste heat recovery increases and securing a quantity of reheating is easy by switching and controlling a mode of the outdoor unit to a cooling leader or a heating leader, when the main coil operates in the cooling mode and the reheating coil operates in the heating mode.

Embodiments disclosed herein provide an air conditioner capable of operating in various modes by driving the main coil in the heating mode and capable of securing the quantity of reheating without heating equipment, such as electric heater and steam, for additional reheating control, when the heating load is too high by measuring the temperature and humidity. Embodiments disclosed herein provide the air conditioner capable of minimizing use of valves while it is controlled in various drive modes.

A thermo-hygrostat air conditioner according to embodiments disclosed herein may include at least one indoor unit installed indoors, and including a main coil that provides air that meets a set or predetermined humidity by dehumidifying outdoor air and a sub coil that cools or heats the dehumidified air at a set or predetermined temperature and provides it indoors; and an outdoor unit connected to the main coil and the sub coil of the indoor unit via a refrigerant pipe and including an outdoor heat exchanger, a compressor, an outdoor expansion valve and a four way valve. A mode of the main coil and the sub coil may be determined depending on a cooling load and a heating load. The outdoor unit may control the four way valve according to the mode of the main coil and the sub coil and provide refrigerant to the mode of the main coil and the sub coil.

The thermo-hygrostat air conditioner may further include a valve installed at the refrigerant pipe between at least one indoor unit and the outdoor unit and that bypasses, depending on the mode, the refrigerant flowing to the main coil and the sub coil.

The refrigerant pipe may include a liquid line connection pipe in which liquid refrigerant with high pressure flows; a first gas line connection pipe in which gaseous refrigerant with low or high pressure flows; and a second gas line connection pipe in which gaseous refrigerant with low or high pressure flows. The liquid line connection pipe may be branched to a first indoor liquid line pipe connected to the main coil and to a second indoor liquid line pipe connected to the sub coil.

The refrigerant pipe may further include a bypass pipe that connects the first gas line connection pipe and the second gas line connection pipe. The valve may include a bypass valve installed at the bypass pipe that bypasses refrigerant flowing in the first gas line connection pipe into the second gas line connection pipe.

The valve may further comprise a gas line valve installed at the second gas line connection pipe and selectively allowing refrigerant to flow into the second gas line connection pipe by being on/off exclusively with the bypass valve.

The first gas line connection pipe may be connected with the sub coil. The second gas line connection pipe may be connected with the main coil.

The thermo-hygrostat air conditioner may further include a main coil expansion valve installed at the first liquid line connection pipe and allowing liquid refrigerant to flow into the main coil or expanding liquid refrigerant, and a sub coil expansion valve installed at the second liquid line connection pipe and allowing liquid refrigerant to flow into the main coil or expanding liquid refrigerant. The bypass valve may supply refrigerant in the first gas line connection pipe to the main coil and the sub coil simultaneously by being turned on when the main coil and the sub coil operate in the heating mode.

The indoor unit may include an outdoor air suction hole installed at a front end of the main coil and suctioning outdoor air; a circulating air suction hole installed at the front end of the main coil and suctioning air circulating indoors; and an air discharge hole installed at a rear end of the sub coil and discharging air indoors. The indoor unit may include a plurality of temperature-humidity sensors adjacent to the outdoor air suction hole, the circulating air suction hole, and the air discharge hole, and that sense a temperature and a humidity of outdoor air, circulating air, and discharged air.

The thermo-hygrostat air conditioner may periodically measure temperature and humidity from the plurality of temperature-humidity sensors and then calculate a heating load and a cooling load of the indoor unit. The mode of the main coil and the sub coil may be determined according to the calculated heating load and cooling load. A mode of the outdoor unit may be determined according to a magnitude of the heating load and the cooling load.

A method for controlling a thermo-hygrostat air conditioner according to embodiments disclosed herein is provided. The thermo-hygrostat air conditioner may include a thermo-hygrostat indoor unit installed indoors and including a main coil and a sub coil; and an outdoor unit connected with the main coil and the sub coil of the indoor unit via a refrigerant pipe and including an outdoor heat exchanger, a compressor, an outdoor expansion valve and a four way valve. The method may include receiving a sensing signal from a plurality of temperature-humidity sensors of the indoor unit; determining a cooling mode of the main coil for dehumidification of the air by comparing a set or predetermined humidity with a current humidity; determining a heating mode of the main coil for reheating the air by comparing a set or predetermined temperature with a current temperature; determining a mode of the outdoor unit depending on a magnitude of a cooling load of the main coil and a heating load of the sub coil, when the main coil is in a cooling mode and the sub coil is in a heating mode; allowing flow of refrigerant into the main coil and the sub coil simultaneously, by controlling the compressor and the four way valve depending on the mode determined. The allowing flow of refrigerant into the main coil and the sub coil may include bypassing the refrigerant flowing into the main coil and the sub coil according to the mode.

The refrigerant pipe may include a liquid line connection pipe in which liquid refrigerant flows with high pressure; a first gas line connection pipe in which gaseous refrigerant flows with high or low pressure; a second gas line connection pipe in which gaseous refrigerant flows with high or low pressure. The bypassing of the refrigerant may include bypassing refrigerant flowing in the first gas line connection pipe to the second gas line connection pipe, by connecting the first gas line connection pipe and the second gas line connection pipe, when the main coil and the sub coil operate in heating mode.

The first gas line connection pipe may be connected with the sub coil. The second gas line connection pipe may be connected with the main coil.

The thermo-hygrostat air conditioner may prevent refrigerant in the second gas line connection pipe from flowing into the main coil, when the first gas line connection pipe and the second gas line connection pipe are bypassed.

The indoor unit may include an outdoor air suction hole installed at a front end of the main coil and suctioning outdoor air; a circulating air suction hole installed at the front end of the main coil and suctioning air circulating indoors; and an air discharge hole installed at a rear end of the sub coil and discharging air indoors; and a plurality of temperature-humidity sensors adjacent to the outdoor air suction hole, the circulating air suction hole, and the air discharge hole, that sense a temperature and a humidity of outdoor air, circulating air, and discharged air. The sensing of the sensing signal periodically may receive temperature and humidity from the plurality of temperature-humidity sensors.

The thermo-hygrostat air conditioner may periodically receive the sensing signal and then may perform a flow control when the main coil and the sub coil operate in different modes to each other.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section could be termed a second element, component, region, layer or section without departing from the teachings of the present invention.

Spatially relative terms, such as “lower”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative to the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments are described herein with reference to cross-section illustrations that are schematic illustrations of idealized embodiments (and intermediate structures). As such, variations from the shapes of the illustrations as a result, for example, of manufacturing techniques and/or tolerances, are to be expected. Thus, embodiments should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any reference in this specification to “one embodiment,” “an embodiment,” “example embodiment,” etc., means that a particular feature, structure, or characteristic described in connection with the embodiment is included in at least one embodiment. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A thermo-hygrostat air conditioner, comprising:
at least one indoor unit installed indoors, and including a main coil that provides air that meets a predetermined humidity by dehumidifying outdoor air and a sub coil that cools or heats the dehumidified air to a predetermined temperature and provides the air indoors; and
an outdoor unit connected to the main coil and the sub coil of the at least one indoor unit via a refrigerant pipe and including at least one outdoor heat exchanger, at least one compressor, at least one outdoor expansion valve, and at least one four way valve, wherein a mode of the main coil and the sub coil is determined depending on a cooling load and a heating load of the at least one indoor unit, wherein the outdoor unit controls the four way valve according to the mode of the main coil and the sub coil and provides refrigerant according to the mode of the main coil and the sub coil.

2. The thermo-hygrostat air conditioner according to claim 1, further comprising:
a valve installed at the refrigerant pipe between the at least one indoor unit and the outdoor unit that bypasses the refrigerant flowing, depending on the mode, to the main coil and the sub coil.

3. The thermo-hygrostat air conditioner according to claim 2, wherein the refrigerant pipe comprises:
a liquid line connection pipe in which liquid refrigerant at high pressure flows;
a first gas line connection pipe in which gaseous refrigerant at low or high pressure flows;
a second gas line connection pipe in which gaseous refrigerant at low or high pressure flows.

4. The thermo-hygrostat air conditioner according to claim 3, wherein the liquid line connection pipe is branched to a first indoor liquid line pipe connected to the main coil and to a second indoor liquid line pipe connected to the sub coil.

5. The thermo-hygrostat air conditioner according to claim 4, wherein the refrigerant pipe further comprises:
a bypass pipe that connects the first gas line connection pipe and the second gas line connection pipe, and wherein the valve comprises:
a bypass valve installed at the bypass pipe that bypasses refrigerant flowing in the first gas line connection pipe into the second gas line connection pipe.

6. The thermo-hygrostat air conditioner according to claim 5, wherein the valve further comprises:
a gas line valve installed at the second gas line connection pipe and allowing flow of refrigerant into the second gas line connection pipe by being on/off exclusively with the bypass valve.

7. The thermo-hygrostat air conditioner according to claim 6, wherein the first gas line connection pipe is connected with the sub coil, and wherein the second gas line connection pipe is connected with the main coil.

8. The thermo-hygrostat air conditioner according to claim 7, further comprising:
a main coil expansion valve installed at the first liquid line connection pipe and allowing flow of liquid refrigerant into the main coil or expanding liquid refrigerant; and
a sub coil expansion valve installed at the second liquid line connection pipe and allowing flow of liquid refrigerant into the main coil or expanding liquid refrigerant.

9. The thermo-hygrostat air conditioner according to claim 8, wherein the bypass valve supplies refrigerant in the first gas line connection pipe to the main coil and the sub coil simultaneously by being turned on when the main coil and the sub coil operate in a heating mode.

10. The thermo-hygrostat air conditioner according to claim 9, wherein the at least one indoor unit further comprises:
an outdoor air suction hole provided upstream of the main coil and through which outdoor air is suctioned;
a circulating air suction hole installed upstream of the main coil and through which air circulating indoors is suctioned; and
an air discharge hole installed downstream of the sub coil and through which air is discharged indoors.

11. The thermo-hygrostat air conditioner according to claim 10, wherein the at least one indoor unit further comprises:
a plurality of temperature-humidity sensors adjacent to the outdoor air suction hole, the circulating air suction hole, and the air discharge hole, that sense a temperature and a humidity of the outdoor air, the circulating air, and the discharged air.

12. The thermo-hygrostat air conditioner according to claim 10, wherein the thermo-hygrostat air conditioner periodically measures temperature and humidity via the plurality of temperature-humidity sensors and then calculates the heating load and the cooling load of the at least one indoor unit, and wherein the mode of the main coil and the sub coil is determined according to the calculated heating load and cooling load.

13. The thermo-hygrostat air conditioner according to claim 12, wherein a mode of the outdoor unit is determined according to a magnitude of the heating load and the cooling load.

14. A method for controlling a thermo-hygrostat air conditioner, the thermo-hygrostat air conditioner comprising at least one thermo-hygrostat indoor unit installed indoors and including a main coil and a sub coil; and an outdoor unit connected with the main coil and the sub coil of the indoor unit via a refrigerant pipe and including at least one outdoor heat exchanger, at least one compressor, at least one outdoor expansion valve, and at least one four way valve, wherein the method comprises:
receiving a sensing signal from a plurality of temperature-humidity sensors of the at least one indoor unit;
determining a cooling mode of the main coil for dehumidification of air by comparing a predetermined humidity with a current humidity;
determining a heating mode of the main coil for reheating the air by comparing a predetermined temperature with a current temperature;
determining a mode of the outdoor unit depending on a magnitude of a cooling load of the main coil and a heating load of the sub coil, when the main coil is in a cooling mode and the sub coil is in a heating mode;
directing refrigerant into the main coil and the sub coil simultaneously, by controlling the at least one compressor and the at least one four way valve depending on the mode determined.

15. The method according to claim 14, wherein the directing of refrigerant into the main coil and the sub coil comprises:
bypassing the refrigerant flowing into the main coil and the sub coil according to the mode.

16. The method according to claim 15, wherein the refrigerant pipe comprises:
a liquid line connection pipe in which liquid refrigerant flows at high pressure;
a first gas line connection pipe in which gaseous refrigerant flows at high or low pressure;
a second gas line connection pipe in which gaseous refrigerant flows at high or low pressure, wherein the bypassing of the refrigerant includes bypassing refrigerant flowing in the first gas line connection pipe to the second gas line connection pipe, by connecting the first gas line connection pipe and the second gas line connection pipe, when the main coil and the sub coil operate in a heating mode.

17. The method according to claim 16, wherein the first gas line connection pipe is connected with the sub coil, and the second gas line connection pipe is connected with the main coil.

18. The method according to claim 17, wherein the thermo-hygrostat air conditioner controls refrigerant in the second gas line connection pipe not to flow into the main coil, when the first gas line connection pipe and the second gas line connection pipe are bypassed.

19. The method according to claim 18, wherein the at least one indoor unit comprises:
an outdoor air suction hole installed upstream of the main coil and through which outdoor air is suctioned;
a circulating air suction hole installed upstream of the main coil and through which air circulating indoors is suctioned; and
an air discharge hole installed downstream of the sub coil and through which air is discharged indoors; and
a plurality of temperature-humidity sensors adjacent to the outdoor air suction hole, the circulating air suction hole, and the air discharge hole, that sense a temperature and a humidity of outdoor air, circulating air, and discharged air, wherein the receiving of the sensing signal comprises periodically receiving temperature and humidity from the plurality of temperature-humidity sensors.

20. The method according to claim 19, wherein the thermo-hygrostat air conditioner periodically receives the sensing signal and then performs flow control when the main coil and the sub coil operate in different modes to each other.

21. A thermo-hygrostat air conditioner, comprising:
at least one indoor unit installed indoors, and including a main coil that dehumidifies outdoor air and a sub coil that cools or heats the dehumidified air to a predetermined temperature and provides the air indoors, wherein a mode of the main coil and the sub coil is determined depending on a cooling load and a heating load of the at least one indoor unit;
an outdoor unit connected to the main coil and the sub coil of the at least one indoor unit via a refrigerant pipe and including at least one outdoor heat exchanger, at least one compressor, at least one outdoor expansion valve, and at least one four way valve; and
a plurality of temperature-humidity sensors, wherein the thermo-hygrostat air conditioner periodically measures temperature and humidity via the plurality of temperature-humidity sensors and then calculates the heating load and the cooling load of the at least one indoor unit, and wherein the mode of the main coil and the sub coil is determined according to the calculated heating load and cooling load.
